(19) United States
(12) Patent Application Publication
(10) Pub. No.: US 2026/0146476 A1
(43) Pub. Date: May 28, 2026

(54) CAM FOLLOWER PUSH BUTTON LATCH

(71) Applicant: B/E Aerospace, Inc., Winston-Salem, NC (US)

(72) Inventors: Twinkle V. Jacob, Winston-Salem, NC (US); Charles B. Cline, High Point, NC (US)

(21) Appl. No.: 19/392,923

(22) Filed: Nov. 18, 2025

Related U.S. Application Data
(60) Provisional application No. 63/725,828, filed on Nov. 27, 2024.

(51) Int. Cl. E05B 65/44; E05B 1/00; E05B 15/04

(52) U.S. Cl. CPC E05B 65/44; E05B 1/0038; E05B 2015/0413; E05B 2015/042; E05B 2015/0448

(57) ABSTRACT

A latch mechanism includes a housing, a push button mounted to the housing for linear motion, a pair of locking pawls pivotably mounted independently to the housing and movable between latched and unlatched positions, a pair of cam rollers rotatably mounted to the push button and positioned to interface with a cam profile formed on the locking pawls, a first biasing system biasing the push button toward an undepressed position, and a second biasing system biasing the locking pawls toward their respective latched position. In use, pressing the push button causes the cam rollers to ride along the cam profiles to pivot the locking pawls toward their unlatched position, and releasing the push button causes the first biasing system to move the push button toward an undepressed position allowing the locking pawls to pivot independently toward their respective latched position.

### CROSS REFERENCE TO RELATED APPLICATION

This application claims the benefit of priority of U.S. Application No. 63/725,828 filed November 27, 2024, which is hereby incorporated by reference in its entirety.

### TECHNICAL FIELD AND BACKGROUND

The present disclosure relates generally to a latch mechanism, and more particularly, to a push button latch mechanism with redundant latching features and premium motion.

Deployable items in aircraft cabins, for instance tray tables, video monitors, privacy panels, and personal storage compartments, must be securely held in a stowed position during takeoff, landing, and turbulence to comply with aviation safety regulations.

Conventional latches for such applications may rely on a single-point locking mechanism or simple spring-biased catches. These conventional latches can be prone to inadvertent release or wear. Moreover, many existing latches lack the tactile quality and refined appearance expected in premium passenger environments.

Accordingly, there is a need for a latch system that provides redundant locking functionality to ensure secure retention under all flight conditions, offers intuitive one-hand operation, and exhibits a premium look and feel consistent with luxury cabin design standards.

### SUMMARY

According to one aspect, the present disclosure is directed to a latch mechanism. In embodiments, the latch mechanism includes a housing, a push button mounted to the housing for linear motion, a pair of locking pawls pivotably mounted independently to the housing, each locking pawl being movable between a latched position and an unlatched position, a pair of cam rollers each being rotatably mounted to the push button and positioned to interface with a cam profile formed on a corresponding one of the pair of locking pawls, a first biasing system configured to bias the push button toward an undepressed position corresponding to the latched position, and a second biasing system configured to bias the pair of locking pawls toward their respective latched position. In use, when the push button is pressed toward the housing, the pair of cam rollers ride along the cam profiles to pivot the pair of locking pawls toward their respective unlatched position, and when the push button is released, the first biasing system moves the push button toward an undepressed position allowing the pair of locking pawls to pivot independently toward their respective latched position under the force of the second biasing system.

In some embodiments, the push button is mounted to the housing for linear motion within at least one sleeve bearing disposed in the housing.

In some embodiments, the first biasing system includes at least one compression spring.

In some embodiments, the second biasing system includes a pair of torsion springs.

In some embodiments, each cam roller is rotatably mounted to a corresponding lateral extension of the push button.

In some embodiments, the cam profiles have a curved shape to provide leverage characteristics selected to reduce required push button actuation force.

In some embodiments, each locking pawl includes a first portion configured to interface with the respective cam roller to effect pivoting of the locking pawl between the latched and unlatched positions, and a second portion configured to engage a separate structure to retain the separate structure in a stowed position.

In some embodiments, the pair of locking pawls are configured to operate redundantly such that each locking pawl is independently engageable with the separate structure to maintain a latched condition if the other locking pawl fails to fully engage the separate structure or becomes disengaged from the separate structure.

In some embodiments, the separate structure is a deployable tray table, and wherein the second portion is configured to interface with a catch formed in a forward end of the deployable tray table.

According to another aspect, the present disclosure is directed to a latch mechanism including a housing, a push button mounted to the housing for linear motion, a pair of locking pawls pivotably mounted independently to the housing, each locking pawl being movable between a latched position and an unlatched position, and a pair of cam rollers, each cam roller being rotatably mounted to the push button, and each cam roller positioned to interface with a cam profile formed on a corresponding one of the pair of locking pawls. In embodiments, the push button is biased toward an undepressed position corresponding to the latched position, and the pair of locking pawls are biased toward their respective latched position. In use, when the push button is pressed toward the housing, the pair of cam rollers ride along their respective cam profile to pivot the pair of locking pawls toward their respective unlatched position, and when the push button is released, the push button moves toward the undepressed position allowing the pair of locking pawls to pivot independently toward their respective latched position.

According to a further aspect, the present disclosure is directed to a tray table assembly including a tray table moveable between a stowed position and a deployed position, and a latch mechanism configured to engage the tray table to maintain the tray table in the stowed position and disengage the tray table to allow the tray table to be moved to the deployed position. In embodiments, the latch mechanism includes a housing, a push button mounted to the housing for linear motion, a pair of locking pawls pivotably mounted independently to the housing and movable between a latched position and an unlatched position, a pair of cam rollers rotatably mounted to the push button and positioned to interface with a cam profile formed on a corresponding one of the pair of locking pawls, a first biasing system configured to bias the push button toward an undepressed position corresponding to the latched position, and a second biasing system configured to bias the pair of locking pawls toward their respective latched position. In use, when the push button is pressed toward the housing, the pair of cam rollers ride along their respective cam profile to pivot the pair of locking pawls toward their respective unlatched position disengaged from the tray table, and when the push button is released, the first biasing system moves the push button toward an undepressed position allowing the pair of locking pawls to pivot independently toward their respective latched position under the force of the second biasing system and into engagement with the tray table.

In some embodiments, each locking pawl includes a first portion configured to interface with the respective cam roller to effect pivoting of the locking pawl between the latched and unlatched positions, and a second portion configured to engage in a catch formed in a forward end of the tray table to retain the tray table in the stowed position.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are examples and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples ("examples") of the disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 illustrates a latch mechanism with a portion of the latch mechanism shown transparent for clarity, in accordance with one or more embodiments of the present disclosure;

FIG. 2 illustrates a tray table assembly shown in a stowed position maintained by the latch mechanism shown in FIG. 1, in accordance with one or more embodiments of the present disclosure;

FIG. 3 illustrates the tray table assembly and latch mechanism positioned in the context of an aircraft passenger cabin, in accordance with one or more embodiments of the present disclosure;

FIG. 4 illustrates the latch mechanism shown in a latched position or state, in accordance with one or more embodiments of the present disclosure;

FIG. 5 is a cross section of the tray table assembly showing the latch mechanism interfacing with the tray table to maintain the tray table in the stowed position, in accordance with one or more embodiments of the present disclosure;

FIGS. 6A and 6B illustrate the respective latched and unlatched positions of the latch mechanism, in accordance with one or more embodiments of the present disclosure; and

FIGS. 7A and 7B illustrate the respective latched and unlatched positions of the locking pawls of the latch mechanism, in accordance with one or more embodiments of the present disclosure.

### DETAILED DESCRIPTION

Reference will now be made in detail to the subject matter disclosed, which is illustrated in the accompanying drawings.

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of sub-combination of two or more such features, along with any other features which may not necessarily be expressly described or inherently present in the instant disclosure.

Broadly, the present disclosure provides a latch mechanism designed for use in an aircraft cabin to securely hold a movable structure, for instance a tray table, personal device surface, or other amenity, in a stowed position during taxi, takeoff, landing, and turbulence. In embodiments, the latch mechanism includes a push button actuator and dual, independently pivotable locking pawls that provide redundant retention, ensuring the structure remains safely secured even under vibration or partial engagement conditions. When a passenger wishes to deploy the tray table, the passenger simply depresses the push button, which drives internal cam rollers against smooth cam profiles on the locking pawls, pivoting the locking pawls out of engagement and allowing the tray table to be lowered to a deployed position. After use, the passenger pushes the tray table back into its stowed position, wherein the spring-biased locking pawls automatically pivot into engagement with catch features located or formed on the tray table, and the push button returns to its original undepressed position. This self-resetting, redundant latching interaction provides reliable hold strength during flight operations while offering a smooth, intuitive, and premium feeling user experience within the cabin. While described in the context of an aircraft passenger cabin, it is intended and understood that the latch mechanism disclosed herein can be used in any application and environment in which a structure is needed to be secured.

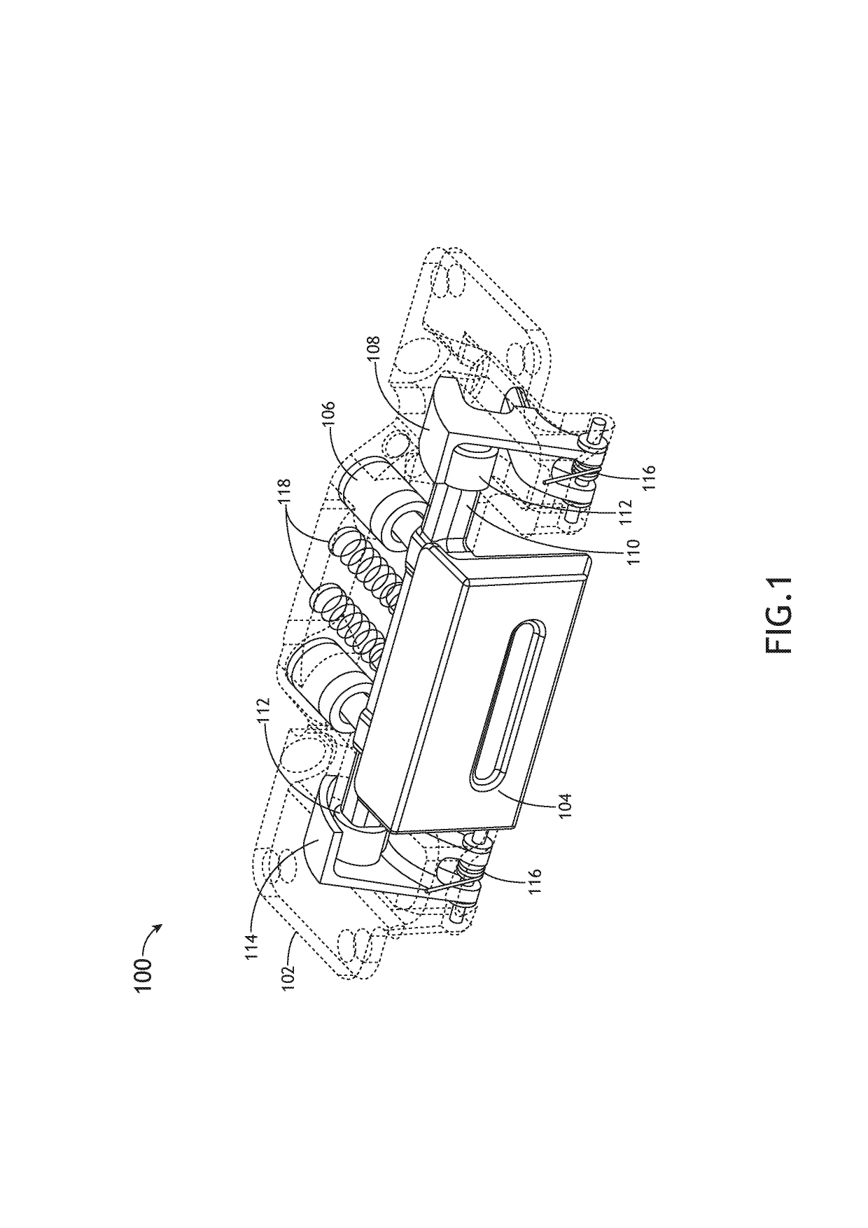

FIG. 1 illustrates a latch mechanism 100 according to the present disclosure. In embodiments, the latch mechanism 100 includes a housing 102 configured to be mounted to a structure within an aircraft cabin, for instance furniture, a passenger seat shell or partition, another passenger seat, etc. A push button 104 is mounted to the housing 102 for linear motion. In embodiments, the push button 104 is mounted for linear motion in at least one sleeve bearing 106 disposed in the housing 102. In embodiments, the push button 104 may be mounted for linear motion in two horizontally spaced sleeve bearings 106 to prevent binding.

The latch mechanism 100 further includes a pair of locking pawls 108 pivotably mounted independently to the housing 102 such that each locking pawl 108 is movable between a latched position and an unlatched position as discussed in detail below. In embodiments, the locking pawls 108 may be positioned to either side of the push button 104. In embodiments, the push button 104 may define a pair of lateral extensions 110 on which a pair of cam rollers 112 are rotatably mounted. Each cam roller 112 is positioned to interface with a cam profile 114 formed on a corresponding one of the pair of locking pawls 108. In this configuration, depressing the push button 104 inward moves the pair of lateral extensions 110 carrying the cam rollers 112 causing the cam rollers 112 to interact with the respective cam profiles 114 to drive pivoting motion of the locking pawls 108.

In embodiments, a fist biasing system associated with the push button 104 includes at least one compression spring 118 configured to bias the push button 104 toward an undepressed position corresponding to a latched position of the locking pawls 108. In embodiments, the first biasing system may include a pair of horizontally spaced compression springs 118 disposed between the pair of sleeve bearings 106. In embodiments, a second biasing system associated with the locking pawls 108 includes a pair of torsion springs 116 configured to bias the pair of locking pawls 108 toward their respective latched position. In embodiments, the torsion springs 116 may be mounted on shafts mounted to the housing 102.

In use, when the push button 104 is pressed toward the housing 104 against the biasing forces of the first and second biasing systems, the pair of cam rollers 112 ride along the cam profiles 114 to pivot the pair of locking pawls 108 toward their respective unlatched position. In use, when the push button 104 is released, the at least one compression spring 118 of the first biasing system moves the push button 104 toward an undepressed position allowing the pair of locking pawls 108 to pivot independently toward their respective latched position under the force of the torsion springs 116 of the second biasing system.

In the biasing system configurations shown, the first and second biasing systems automatically reset the released push button 104 and the locking pawls 108 to their starting positions corresponding to the latched position. When in the latched position ready to receive a separate structure to be stowed and secured, the biased locking pawls 108 deflect (e.g., pivot) upon contact with the structure that is being stowed to then engage with the structure in its stowed position. This ability to automatically reset and ready the mechanism for latching allows the structure to be stowed and secured with one-hand without having to actuate the push button 104. Likewise, the structure can be released with one-hand by actuating the push button 104, although the other hand may be used to handle and control the deploying motion of the structure (e.g., tray table). In embodiments, the deploying motion of the structure can be controlled by a damper or like mechanism to prevent uncontrolled falling.

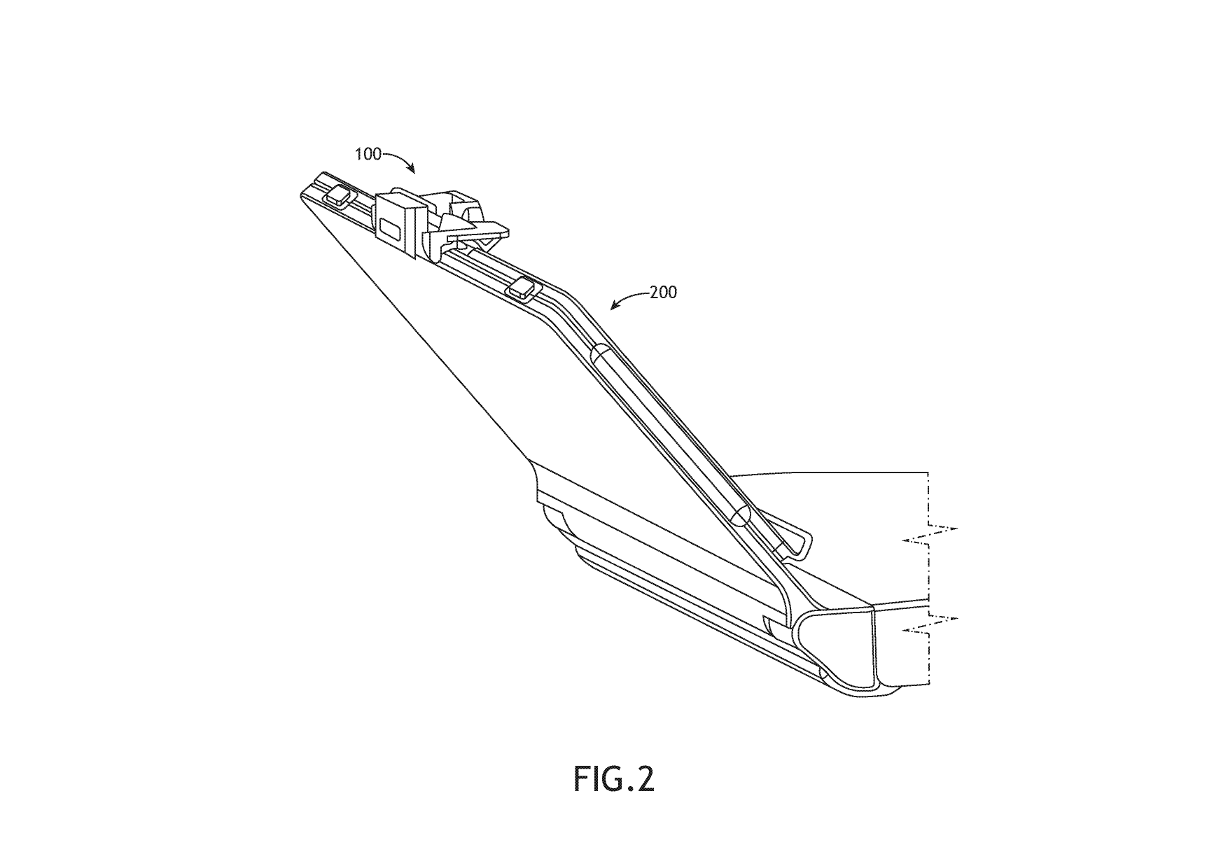

FIG. 2 illustrates the latch mechanism 100 associated with a tray table 200. In embodiments, the tray table 200 may be configured to move between a stowed position as shown in which the tray table 200 is at an angle to horizontal (e.g., upright or steep angle), and a horizontal use position corresponding to the deployed position. In embodiments, the tray table 200 may be a bi-fold table as shown in which the tray table 200 may be deployed and then unfolded to increase the usable surface area. In embodiments, the tray table 200 may be compatible for use with adjustment mechanisms for adjusting the deployed tray table 200 in at least one of fore, aft, and lateral directions.

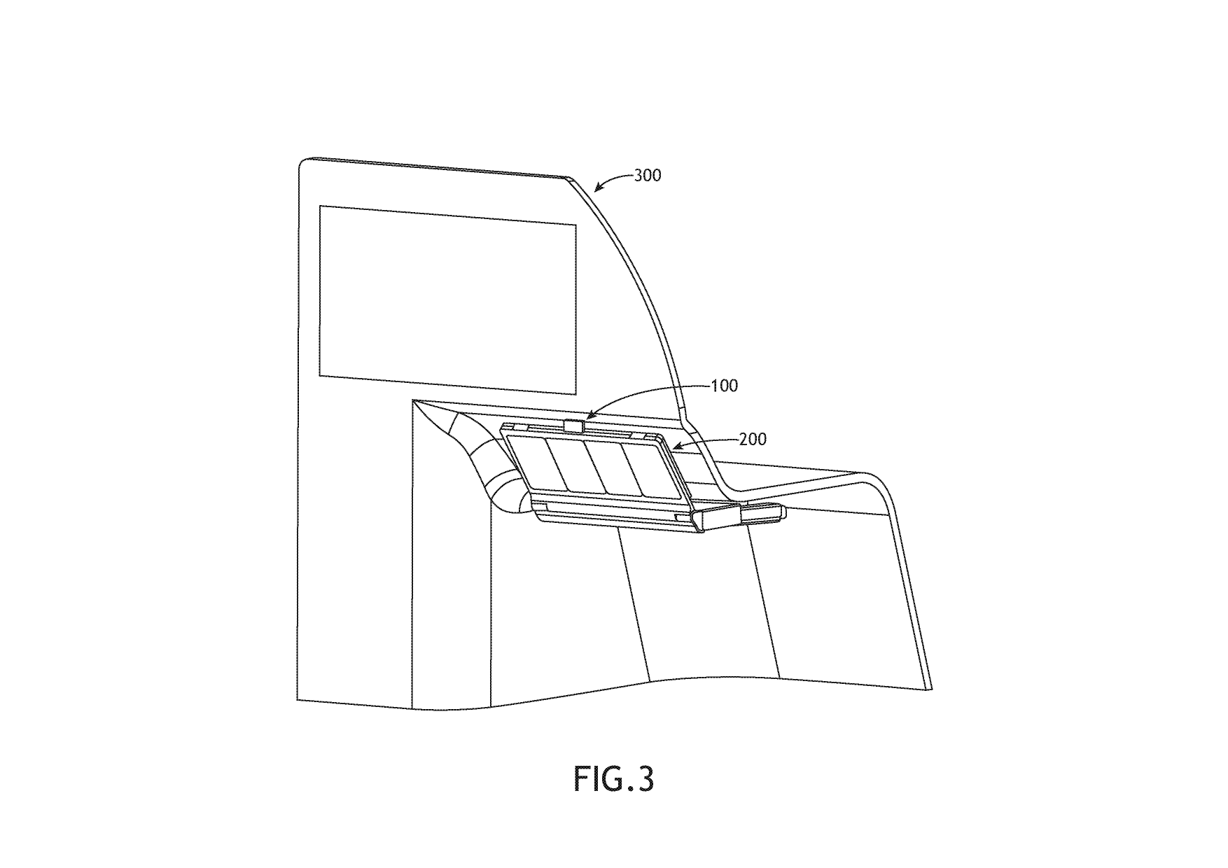

FIG. 3 illustrates the latch mechanism 100 and tray table 200 in the context of a passenger seat environment in an aircraft cabin. In embodiments, a shell 300 associated with a passenger seat may serve as a mounting location for the latch mechanism 100, wherein the tray table 200 is disposed beneath a horizontal surface of the shell 300, the latch mechanism 100 mounts to the shell 300, and the tray table 200 stows at a steep angle against the shell 300 and away from the legroom designated for the passenger seat (not shown) facing the tray table 200. In use, the latch mechanism 100 may be actuated to release the tray table 200 for use during flight and may be used to secure the tray table in the stowed position during taxi, takeoff, landing, and turbulence.

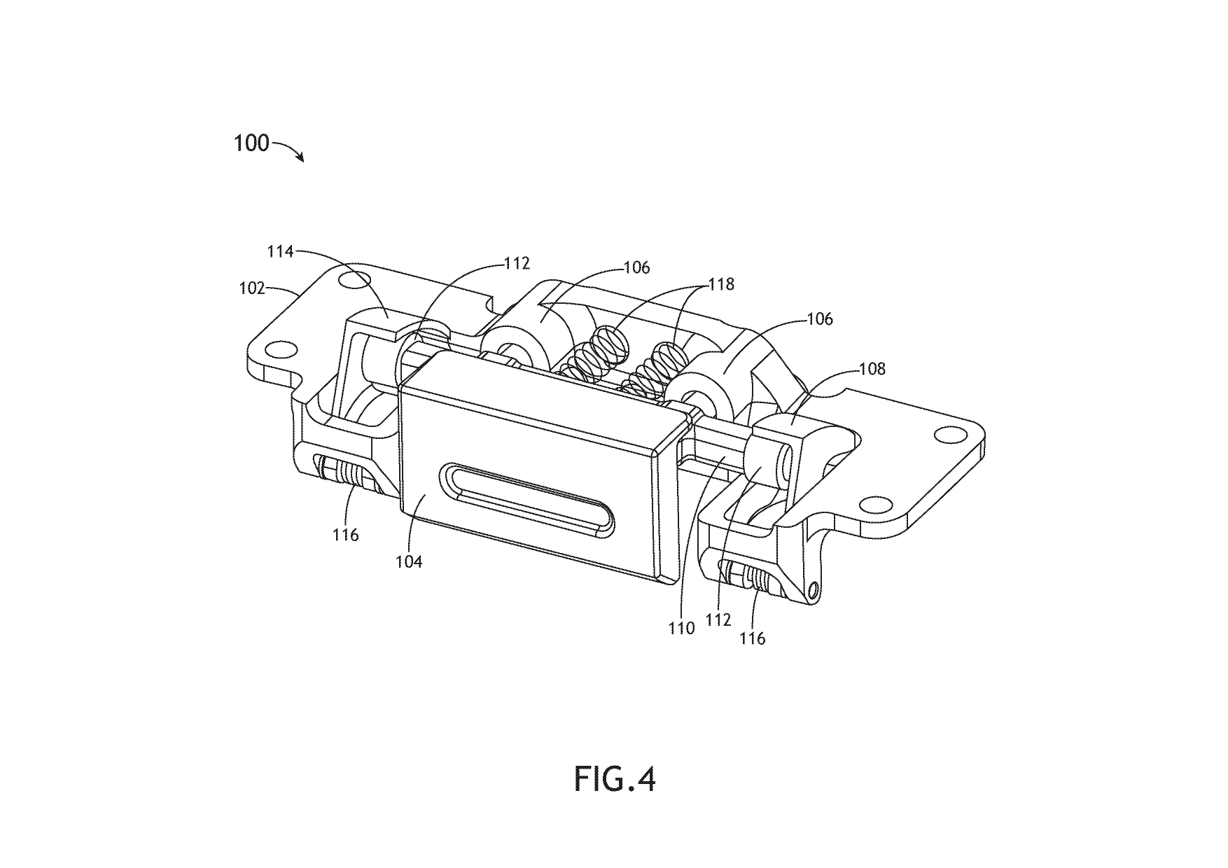

FIG. 4 illustrates the latch mechanism 100 wherein the locking pawls 108 are movable relative to the housing 102 between their latched position (shown) and their unlatched position.

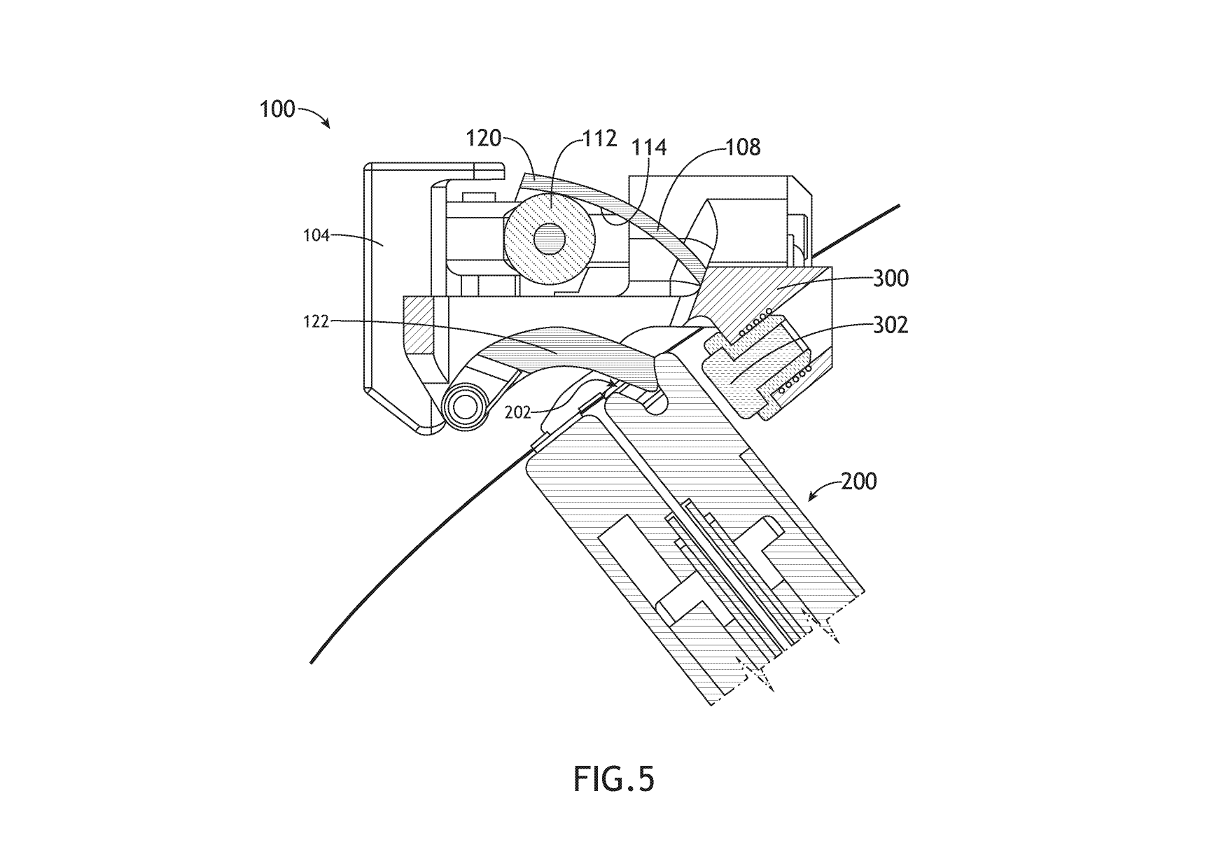

FIG. 5 illustrates the latch mechanism 100 wherein the locking pawls 108 are shown in their latched position securing the tray table 200 in the stowed position. In embodiments, each locking pawl 108 defines a cam profile 114 having a curved shape to provide leverage characteristics selected to reduce required push button actuation force. In embodiments, each locking pawl 108 may include a first portion 120 defining the cam profile 114 configured to interface with the respective cam roller 112 to effect pivoting of the locking pawl 108 between the latched and unlatched positions, and a second portion 122 configured to engage a separate structure (e.g., tray table 200) to retain the separate structure in a stowed position. In embodiments, the cam roller 112 is disposed between the first and second portions 120, 122. In embodiments, the second portion 122 may be pivotably attached to the housing 102 and the first portion 120 may be free of attachment to the housing 102.

In embodiments, the shell 300 to which the latch mechanism 100 is mounted may include a stopper 302 for damping stowing motion by absorbing kinetic energy and softening the impact when the separate structure (e.g., tray table 200) reaches its fully stowed position. Made from compliant materials such as silicone or rubber, the stopper 302 is configured to deform under load to dissipate energy through controlled compression rather than allowing a hard, abrupt stop. This not only protects the mechanism from shock-induced wear and noise but also provides a smoother, more refined user experience. In embodiments, the geometry, hardness, and placement of the stopper 302 can be customized to control the range of motion and damping characteristics. In some embodiments, the stopper may by externally threaded and turned to adjust its position. In some embodiments, the stopper 302 may be integrated into the latch mechanism 100.

In use, the pair of locking pawls 108 are configured to operate redundantly such that each locking pawl 108 is independently engageable with the separate structure to maintain a latched condition if the other locking pawl fails to fully engage the separate structure or becomes disengaged from the separate structure. In embodiments, the separate structure is a deployable tray table 200 and the second portions 122 of the pair of locking pawls 108 are configured to interface with a catch 202 formed in a forward end of the deployable tray table 202. The catch 202 may be implemented as separate catches one for each locking pawl 108, a singular elongated groove, etc. In use, when the tray table 200 is stowed, the second portion 122 of the pair of locking pawls 108 constrains forward/lowering motion of the tray table 200. When the push button 104 is pressed, the cam rollers 112 effect pivoting motion of the pair of locking pawls 108 thereby ‘raising’ the second portion 122 out of engagement with the catch 202 on the tray table 200 thereby allowing the tray table 200 to be deployed.

In embodiments, the smooth, curved cam profile 114 can be selected to provide a favorable leverage characteristic that reduces the force required to actuate the push button 104. By varying the cam profile 114, a mechanical advantage can be created that increases as the user begins to press the push button 104, allowing the cam to do more work with less input force. In addition, the gradual curvature also ensures a continuous and predictable transfer of motion, avoiding sudden changes in resistance that could feel abrupt or uncomfortable. As a result, a compact push button 104 can deliver a light, responsive actuation while still generating the necessary internal displacement or load, improving both ergonomics and overall precise performance.

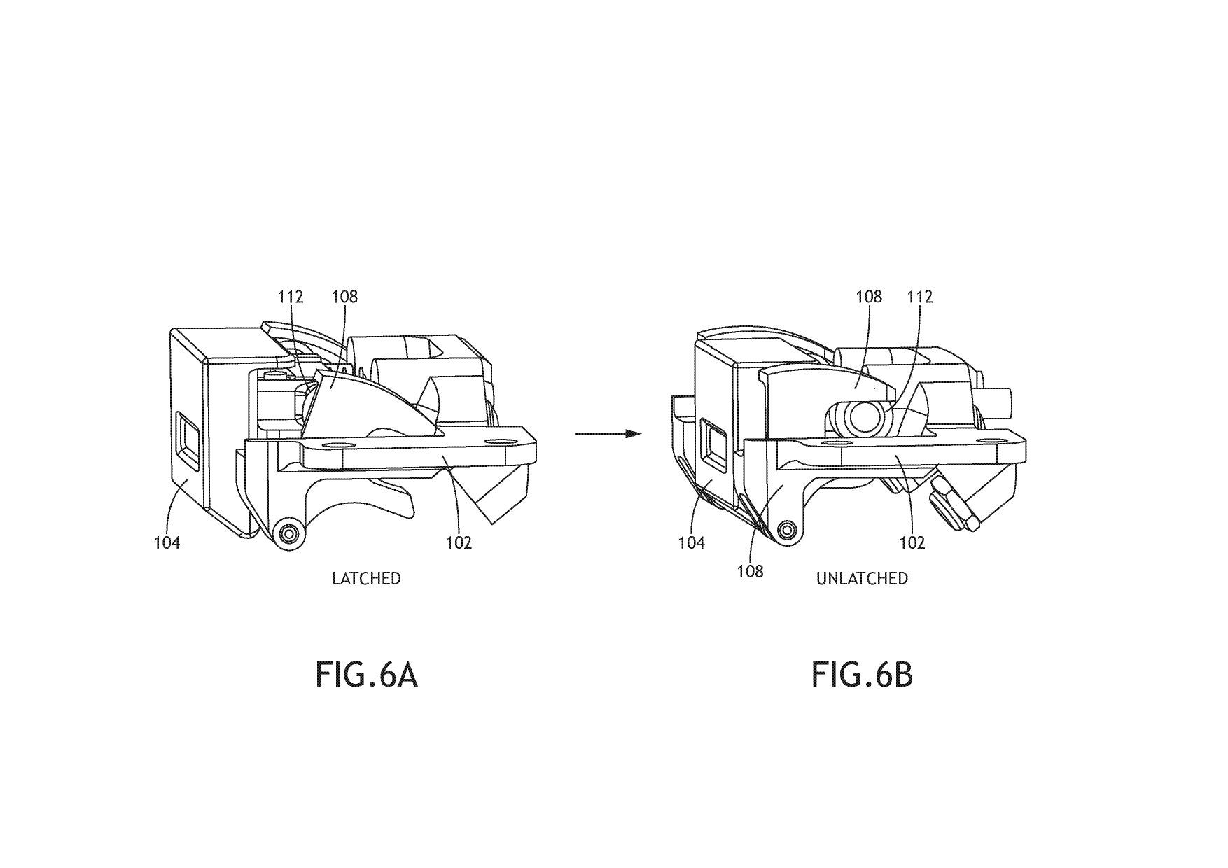

FIGS. 6A and 6B illustrate the respective latched and unlatched positions of the pair of locking pawls 108 and their dispositions relative to the housing 102. FIG. 6A illustrates the push button 104 in a released state such that the pair of locking pawls 108 are in their latched positions. In use, when the push button 104 is pressed inward to achieve the unlatched position shown in FIG. 6B, the cam rollers 112 effect the pivoting motion of the pair of locking pawls 108 by transitioning linear push button motion into angular motion.

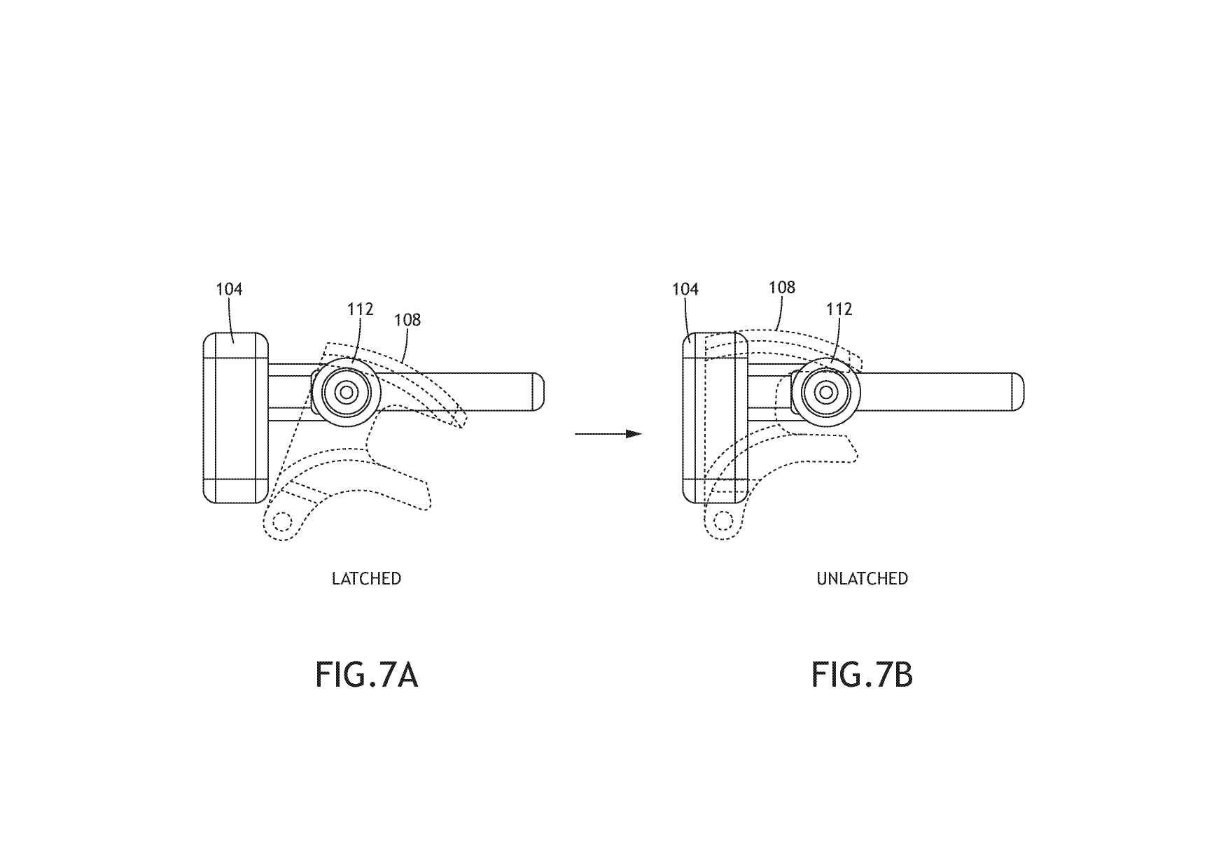

FIGS. 7A and 7B illustrate the relative dispositions of the push button 104 and cam rollers 112 relative to the locking pawls 108 in the respective latched and unlatched positions. As the cam rollers 112 advance along the cam profiles, the cam rollers 112 follow the contour with minimal friction (e.g., nylon rollers), allowing the applied force to be smoothly transitioned into a pivoting action about the locking pawl hinge points. This interaction provides precise timing and displacement, ensuring that the locking pawls 108 engage at the correct moment within the motion cycle. The rolling interface between the cam rollers 112 and the cam profile reduce wear, noise, and the required actuation force with consistent performance over repeated use.

Although the disclosure has been described with reference to the embodiments illustrated in the attached drawing figures, equivalents may be employed and substitutions made herein without departing from the scope of the claims. Components illustrated and described herein are merely examples of a system/device and components that may be used to implement embodiments of the disclosure and may be replaced with other devices and components without departing from the scope of the claims. Furthermore, any dimensions, degrees, and/or numerical ranges provided herein are to be understood as non-limiting examples unless otherwise specified in the claims.

What is claimed:

1. A latch mechanism, comprising:
a housing;
a push button mounted to the housing for linear motion;
a pair of locking pawls pivotably mounted independently to the housing, each locking pawl being movable between a latched position and an unlatched position;
a pair of cam rollers, each cam roller being rotatably mounted to the push button, and each cam roller positioned to interface with a cam profile formed on a corresponding one of the pair of locking pawls;
a first biasing system configured to bias the push button toward an undepressed position corresponding to the latched position; and
a second biasing system configured to bias the pair of locking pawls toward their respective latched position;
wherein, when the push button is pressed toward the housing, the pair of cam rollers ride along the cam profiles to pivot the pair of locking pawls toward their respective unlatched position; and
wherein, when the push button is released, the first biasing system moves the push button toward an undepressed position allowing the pair of locking pawls to pivot independently toward their respective latched position under the force of the second biasing system.

2. The latch mechanism of claim 1, wherein the push button is mounted to the housing for linear motion within at least one sleeve bearing disposed in the housing.

3. The latch mechanism of claim 1, wherein the first biasing system comprises at least one compression spring.

4. The latch mechanism of claim 1, wherein the second biasing system comprises a pair of torsion springs.

5. The latch mechanism of claim 1, wherein each cam roller is rotatably mounted to a corresponding lateral extension of the push button.

6. The latch mechanism of claim 1, wherein the cam profiles have a curved shape to provide leverage characteristics selected to reduce required push button actuation force.

7. The latch mechanism of claim 1, wherein each locking pawl comprises:
a first portion configured to interface with the respective cam roller to effect pivoting of the locking pawl between the latched and unlatched positions; and
a second portion configured to engage a separate structure to retain the separate structure in a stowed position.

8. The latch mechanism of claim 7, wherein the pair of locking pawls are configured to operate redundantly such that each locking pawl is independently engageable with the separate structure to maintain a latched condition if the other locking pawl fails to fully engage the separate structure or becomes disengaged from the separate structure.

9. The latch mechanism of claim 7, wherein the separate structure is a deployable tray table, and wherein the second portion is configured to interface with a catch formed in a forward end of the deployable tray table.

10. A latch mechanism, comprising:
a housing;
a push button mounted to the housing for linear motion;
a pair of locking pawls pivotably mounted independently to the housing, each locking pawl being movable between a latched position and an unlatched position; and
a pair of cam rollers, each cam roller being rotatably mounted to the push button, and each cam roller positioned to interface with a cam profile formed on a corresponding one of the pair of locking pawls;
wherein the push button is biased toward an undepressed position corresponding to the latched position, and the pair of locking pawls are biased toward their respective latched position;
wherein, when the push button is pressed toward the housing, the pair of cam rollers ride along their respective cam profile to pivot the pair of locking pawls toward their respective unlatched position; and
wherein, when the push button is released, the push button moves toward the undepressed position allowing the pair of locking pawls to pivot independently toward their respective latched position.

11. The latch mechanism of claim 10, wherein the push button is mounted to the housing for linear motion within at least one sleeve bearing disposed in the housing.

12. The latch mechanism of claim 10, wherein the push button is biased by at least one compression spring disposed between the push button and the housing.

13. The latch mechanism of claim 10, wherein the pair of locking pawls are biased by a respective pair of torsion springs mounted to the housing.

14. The latch mechanism of claim 10, wherein each cam roller is rotatably mounted to a corresponding lateral extension of the push button.

15. The latch mechanism of claim 1, wherein the cam profiles have a curved shape to provide leverage characteristics selected to reduce required push button actuation force.

16. A tray table assembly, comprising:
a tray table moveable between a stowed position and a deployed position; and
a latch mechanism configured to engage the tray table to maintain the tray table in the stowed position and disengage the tray table to allow the tray table to be moved to the deployed position, the latch mechanism comprising:
a housing;
a push button mounted to the housing for linear motion;
a pair of locking pawls pivotably mounted independently to the housing, each locking pawl being movable between a latched position and an unlatched position;
a pair of cam rollers, each cam roller being rotatably mounted to the push button, and each cam roller positioned to interface with a cam profile formed on a corresponding one of the pair of locking pawls;
a first biasing system configured to bias the push button toward an undepressed position corresponding to the latched position; and
a second biasing system configured to bias the pair of locking pawls toward their respective latched position;
wherein, when the push button is pressed toward the housing, the pair of cam rollers ride along their respective cam profile to pivot the pair of locking pawls toward their respective unlatched position disengaged from the tray table; and
wherein, when the push button is released, the first biasing system moves the push button toward an undepressed position allowing the pair of locking pawls to pivot independently toward their respective latched position under the force of the second biasing system and into engagement with the tray table.

17. The tray table assembly of claim 16, wherein:
the push button is mounted to the housing for linear motion within at least one sleeve bearing disposed in the housing;
the first biasing system comprises at least one compression spring;
the second biasing system comprises a pair of torsion springs; and
each cam roller is rotatably mounted to a corresponding lateral extension of the push button.

18. The tray table assembly of claim 1, wherein the cam profiles have a curved shape to provide leverage characteristics selected to reduce required push button actuation force.

19. The tray table assembly of claim 16, wherein each locking pawl comprises:
a first portion configured to interface with the respective cam roller to effect pivoting of the locking pawl between the latched and unlatched positions; and
a second portion configured to engage in a catch formed in a forward end of the tray table to retain the tray table in the stowed position.

20. The tray table assembly of claim 16, wherein the pair of locking pawls are configured to operate redundantly such that each locking pawl is independently engageable with the tray table to maintain a latched condition if the other locking pawl fails to fully engage the tray table or becomes disengaged from the tray table.
